(19) United States
(12) Patent Application Publication
(10) Pub. No.: US 2026/0230342 A1
(43) Pub. Date: Aug. 6, 2026

(54) DO NOT DISTURB OVERRIDE DURING VIDEO CONFERENCING BASED ON USER AUDITORY STATE

(71) Applicant: MOTOROLA MOBILITY LLC, WILMINGTON, DE (US)

(72) Inventors: AMIT KUMAR AGRAWAL, BANGALORE (IN); Daniela Gareri, Sunnyvale, CA (US); MANOJ JAIN, BANGALORE (IN)

(21) Appl. No.: 19/042,755

(22) Filed: Jan. 31, 2025

(51) Int. Cl. H04L 12/18

(52) U.S. Cl. CPC H04L 12/1822; H04L 65/403; H04M 1/72451

(57) ABSTRACT

A method provides techniques for Do Not Disturb override during video conferencing, based on user auditory state. A connection is established from an electronic device to a video conferencing session with one or more second devices, where the electronic device operates as a conferencing system terminal for a participant to the video conferencing session that includes multiple participants. An incoming notification is detected for surfacing on the electronic display while a Do Not Disturb (DND) feature is enabled for the conferencing system terminal. In response to receiving the incoming notification while the DND feature is enabled, a current auditory state of a user is determined, and in response to determining the current auditory state as a non-speaking state, the method includes overriding the DND feature, and surfacing the incoming notification.

### BACKGROUND

### 1. Technical Field

The present disclosure generally relates to electronic communication devices, and more specifically to multi-device audio/video conferencing via electronic communication devices.

### 2. Description of the Related Art

Online/virtual meetings play a crucial business role in ensuring productivity and collaboration, especially when leveraging conference systems such as Microsoft Teams, Webex, Zoom, or similar platforms. In addition to voice communication, modern audio/video conferencing platforms provide the ability to share video, present materials such as PowerPoint slides, allow whiteboarding, and may even allow one participant to temporarily take control of an electronic device of another participant, e.g., as part of a technical support session or tutorial. Additionally, many platforms provide the ability to send text-based messages (e.g., via a chat interface) during a video conference. Using text-based messaging during a video conference, participants can share thoughts, questions, or resources without disrupting the flow of the discussion. Additionally, with text-based messaging, conference participants can engage in side conversations regarding specific topics, without derailing the main agenda. Text-based messaging during video conferences can thus enhance productivity, inclusivity, and the overall effectiveness of meetings.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2A illustrates an example teleconferencing environment, according to one or more embodiments;

FIG. 2B illustrates the example teleconferencing environment of FIG. 2A, showing the auditory state of each participant, according to one or more embodiments;

FIG. 2C illustrates the example teleconferencing environment of FIG. 2A, showing additional conversation and text-based messaging destined to a non-speaking participant, according to one or more embodiments;

FIG. 2D illustrates the example teleconferencing environment of FIG. 2A, showing additional conversation and surfacing of a text-based message on an electronic device associated with a non-speaking participant, according to one or more embodiments;

FIG. 2E illustrates the example teleconferencing environment of FIG. 2A, showing sending a text-based message to a speaking participant, according to one or more embodiments;

FIG. 2F illustrates the example teleconferencing environment of FIG. 2A, showing delaying surfacing a message destined for a speaking participant, according to one or more embodiments;

FIG. 2G illustrates the example teleconferencing environment of FIG. 2A, showing surfacing a message to a participant after the participant has transitioned from speaking to non-speaking, according to one or more embodiments;

FIG. 3 illustrates an exemplary user interface for Do not Disturb override configuration, according to one or more embodiments;

FIG. 4 depicts a flowchart of a computer-implemented method for Do not Disturb override during video conferencing based on user auditory state, according to one or more embodiments; and

FIG. 5 depicts a flowchart of a computer-implemented method for Do not Disturb override during video conferencing based on user auditory state and additional information, according to one or more embodiments.

FIG. 6 depicts a flowchart of a computer-implemented method for Do not Disturb override during video conferencing based on a message sender, according to one or more embodiments.

FIG. 7 depicts a flowchart of a computer-implemented method for Do not Disturb override during video conferencing based on a notification priority, according to one or more embodiments.

FIG. 8 depicts a flowchart of a computer-implemented method for Do not Disturb override during video conferencing based on a notification topic, according to one or more embodiments.

### DETAILED DESCRIPTION

According to aspects of the present disclosure, an electronic device, a method, and a computer program product provide techniques for implementing Do not Disturb override during video conferences, based on user auditory state. Many audio/video conferencing platforms include a Do Not Disturb (DND) feature. The DND feature serves to suppress incoming notifications while an audio/video conference is in progress. The DND feature can avoid notification sounds or pop-ups that could disrupt the flow of the meeting for the participant(s). Since incoming notifications from text-based instant messages are silenced, the DND feature provides a meeting environment that allows participants to stay fully engaged in the ongoing discussion.

While the DND feature in video conferencing applications provides many benefits, the DND feature can present certain disadvantages under specific conditions, such as when participants need to provide or be provided with discreet feedback or corrections in real time. For example, if a participant is sharing incorrect or inappropriate information, the DND feature blocks instant messages from other participants intended to correct the issue privately. In such instances, other participants may have to verbally interrupt the meeting, which can disrupt the flow of the discussion and potentially cause embarrassment. Moreover, important or time-sensitive messages, such as a technical issue with a presentation, missing information, or a scheduling conflict, may go unnoticed, affecting the meeting's effectiveness. Furthermore, some meetings may benefit from side discussions via text-based chat that clarify points or contribute supplementary information. DND silences this type of real-time collaboration. An example of such a scenario can include a meeting where a speaker is presenting financial data but inadvertently uses outdated figures. Another meeting participant attempts to discreetly send a correction through a text-based message such as through the chat, SMS message, or other suitable text-based message, but the DND feature blocks the notification. Accordingly, the DND feature can force the participant to interrupt verbally, disrupting the presentation and possibly creating awkwardness.

The disclosed embodiments address the aforementioned issues by providing an Overridable Do Not Disturb (ODND) feature based on a user auditory state. In a video or audio conference, each participant can have an associated auditory state. The auditory state can include a speaking state, indicative of when the participant is actively talking, and a non-speaking state, indicative of when the participant is not talking but may still be listening. One or more embodiments can allow text-based communication and/or notifications when a participant has a non-speaking auditory state, enabling text-based communication to flow freely. For a participant having an auditory state of speaking, any incoming text-based messages and/or notifications can be deferred until the user transitions from a speaking auditory state to a non-speaking auditory state, unless received from a subset of pre-authorized participants who are able to override the DND state with communication presented even while the participant is speaking. In this way, text-based information can flow between participants freely when they are in a non-speaking auditory state, which can enhance meeting productivity, while speaking participants are shielded from incoming notifications while speaking, serving to reduce distractions and meeting disruptions, except for notifications about very important interruptions originating from select participants.

One or more embodiments can further use other criteria beyond the user's auditory state to further refine the override of the DND feature. The other criteria can include, but is not limited to, the sender of an incoming text-based message and/or notification being within a pre-selected group of approved DND override participants, the topic of an incoming text-based message and/or notification, a scheduled meeting agenda of speakers and associated times, a microphone mute status of a user, and/or the priority of an incoming text-based message and/or notification. As an example, if the topic of an incoming text-based message is relevant to a current topic of discussion, then the incoming text-based message may be given priority to override a DND setting.

One or more embodiments can provide an electronic device that includes: a display; a communications subsystem enabling the electronic device to communicatively connect to at least one second electronic device; a memory having stored thereon a video conferencing application (VCA) comprising an Overridable Do Not Disturb (ODND) module; and at least one processor coupled to the communications subsystem, the display, and the memory and which processes program code of the VCA and the ODND module. The at least one processor is configured to cause the electronic device to: establish a connection from the electronic device to a video conferencing session with one or more second devices, the electronic device operating as a conferencing system terminal for a participant to the video conferencing session comprising a plurality of participants. The at least one processor is further configure to cause the electronic device to: detect an incoming notification for surfacing on the display of the electronic device, while a Do Not Disturb (DND) feature is enabled for the conferencing system terminal; and in response to receiving the incoming notification while the DND feature is enabled: determine a current auditory state of a user; and in response to determining the current auditory state as a non-speaking state, override the DND feature, and surface the incoming notification.

One or more embodiments can provide a method that includes establishing, by at least one processor of an electronic device that includes an electronic display, a connection from the electronic device to a video conferencing session with one or more second devices, the electronic device operating as a conferencing system terminal for a participant to the video conferencing session comprising a plurality of participants. The method includes: detecting an incoming notification for surfacing on the electronic display while a Do Not Disturb (DND) feature is enabled for the conferencing system terminal; and in response to receiving the incoming notification while the DND feature is enabled: determining a current auditory state of a user; and in response to determining the current auditory state as a non-speaking state, overriding the DND feature; and surfacing (rendering and presenting) the incoming notification.

Further embodiments can provide a computer program product including: a non-transitory computer readable medium; and program code on the computer readable medium that when processed by a processor of an electronic device configures the processor to perform functions of the above-described method.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, “some embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

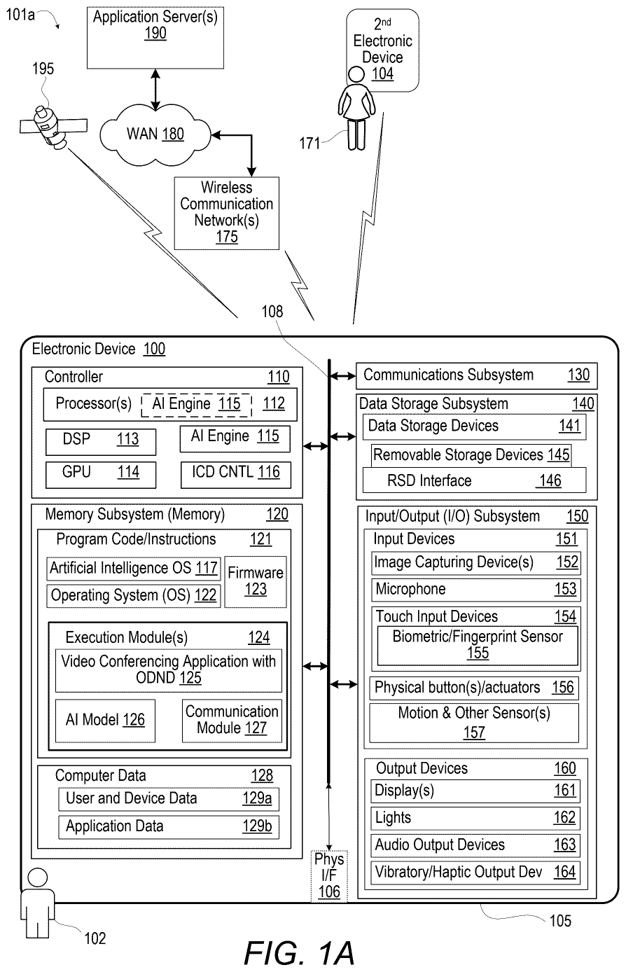

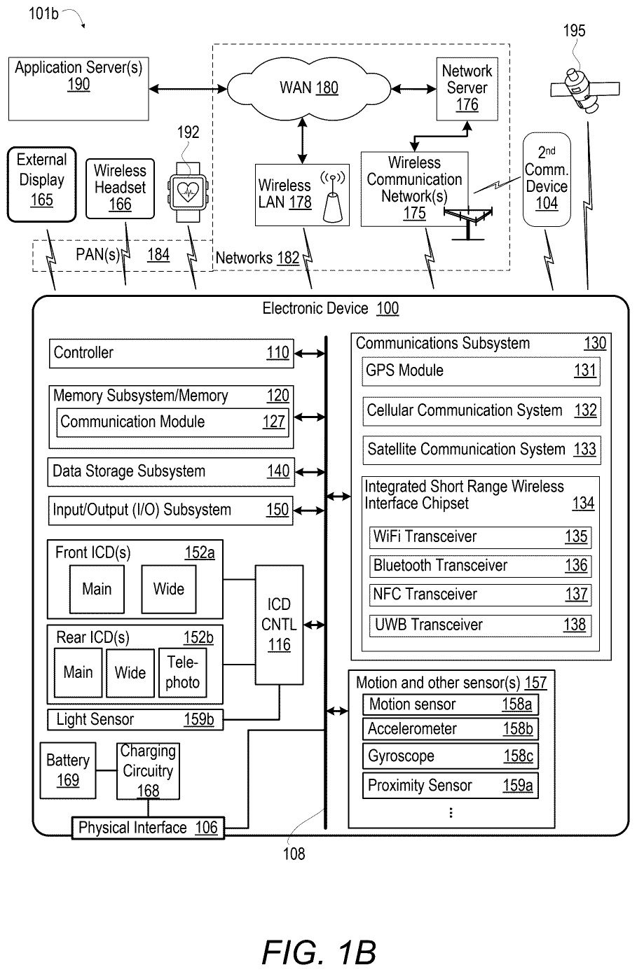

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments.

Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device 100 is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113 graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 117 that can include native support for AI-specific hardware such as Neural Processing Units (NPUs) or Tensor Processing Units (TPUs) to optimize performance for AI tasks such as machine learning inference and training.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, Overridable Do Not Disturb (ODND) module 125, which provides the features and operating functionality of the disclosed embodiments when the corresponding program instructions of Overridable Do Not Disturb (ODND) module 125 are processed by/within processor 112/controller 110.

Execution modules 124 further includes AI model(s) 126. In one or more embodiments, processor 112 can utilize AI models 126 to provide AI functionality of processor-integrated AI engine 115. In other embodiments, AI models 126 are directly utilized by AI engine 115. In one or more embodiments, AI model(s) 126 is integrated as a sub-module within ODND module 125 and is trained to support AI features of ODND module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, ODND module 125 can include program instructions that cause or configure processor 112 to cause electronic device 100 to selectively override a Do Not Disturb (DND) feature for an audio/video conferencing system based on user auditory state. Other features provided by ODND module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of ODND module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by a user to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which follows.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive a user's tactile/touch input. As a touch screen device, integrated display 161 allows a user to provide input to and/or to control electronic device 100 by touching features within a user interface presented on integrated display 161. Tactile, touch input device 154 can include a touch screen interface. The touch screen interface can include one or more virtual buttons or selectable affordances. In one or more embodiments, when a user 102 applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device 100 to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem 130 includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 171 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of ODND module 125 and/or access to other applications, online transactions, and resources. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

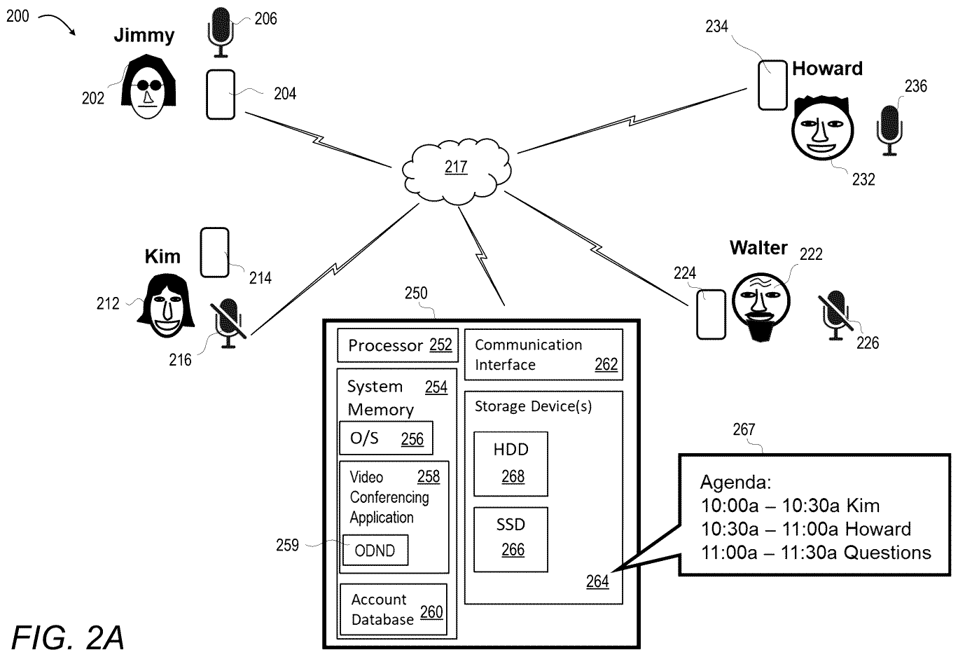

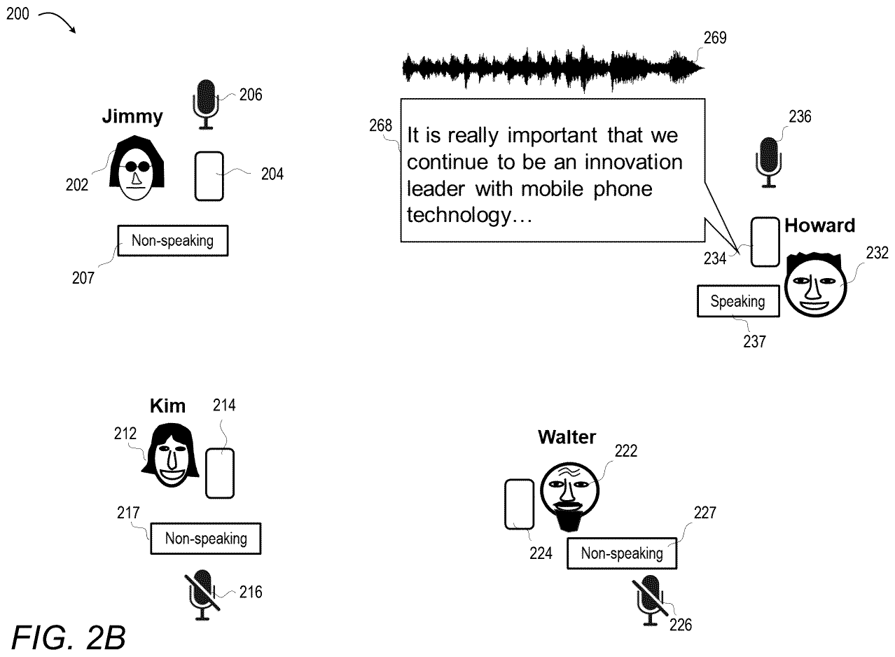

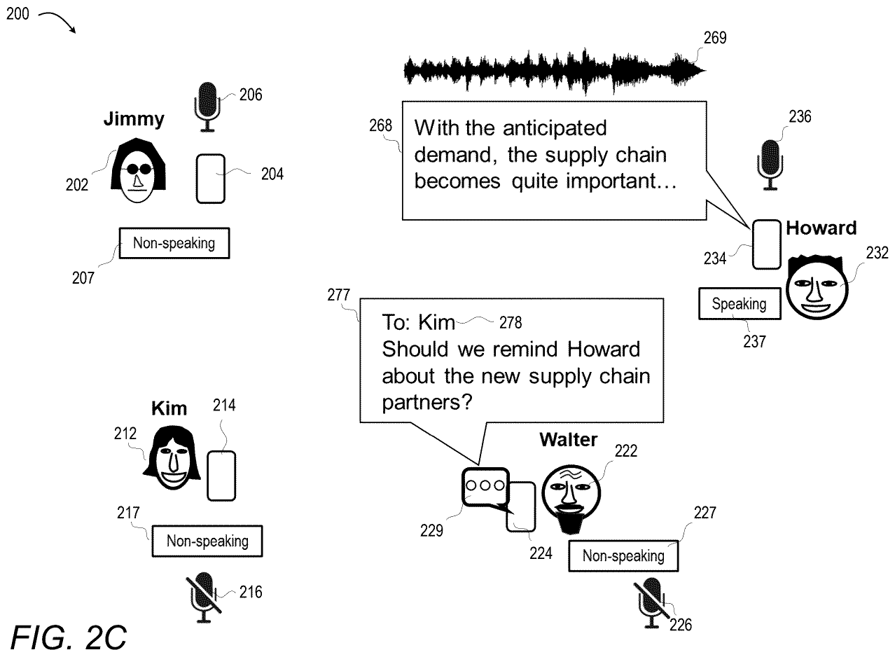

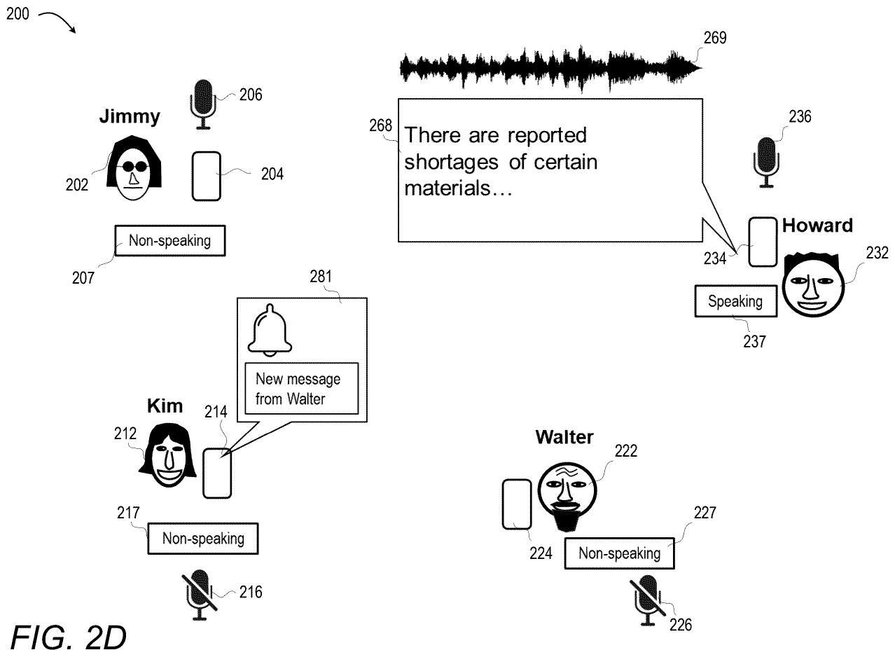

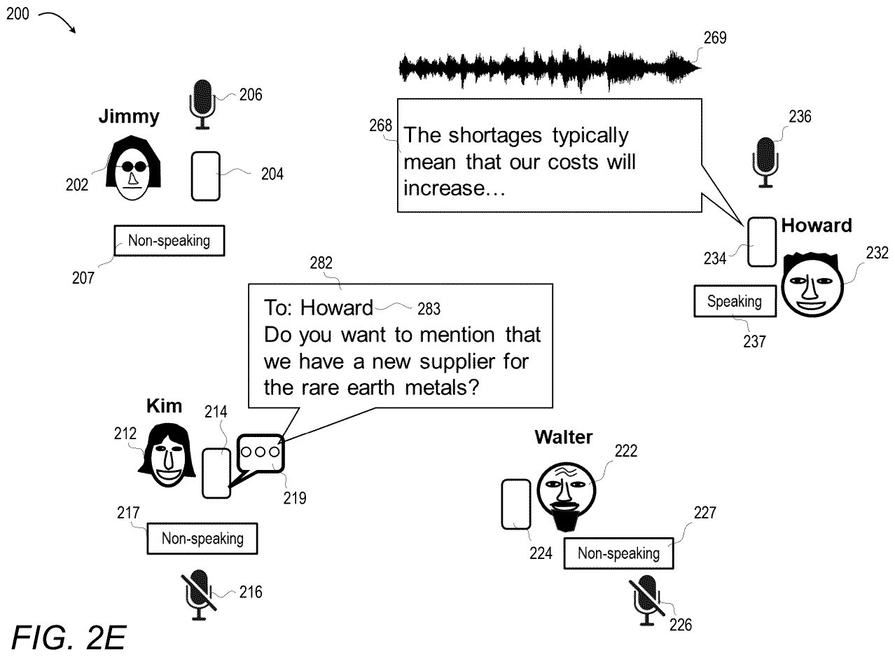

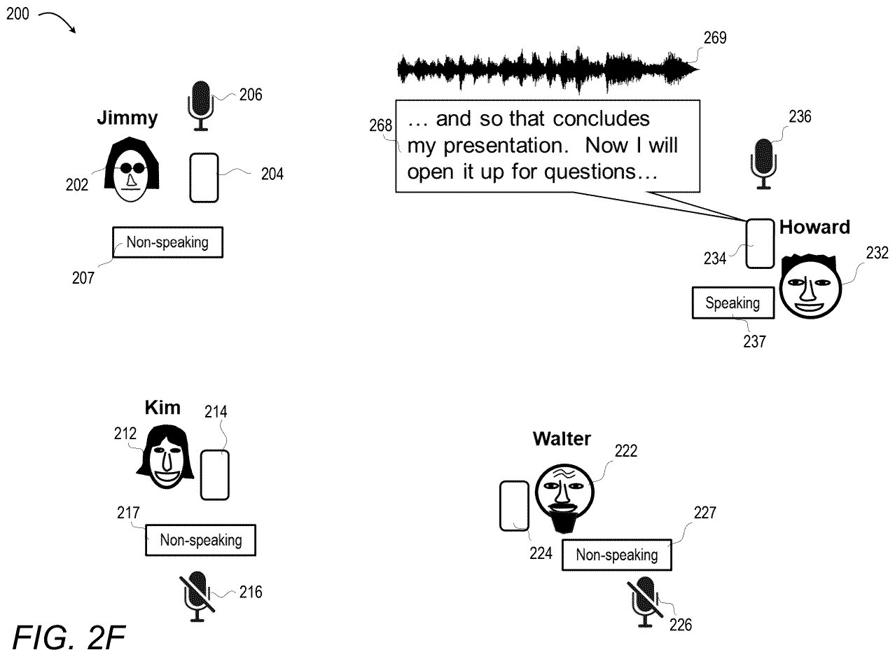

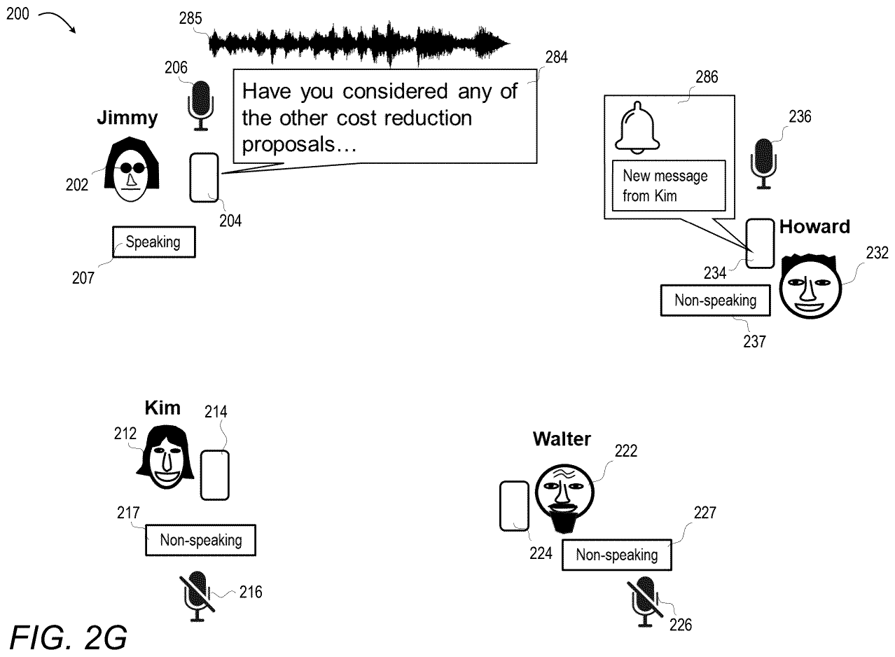

FIG. 2A illustrates an example video teleconferencing environment, according to one or more embodiments. Example teleconferencing environment 200 includes four participants, each having an associated electronic device with which the respective participant connects to the video communication session. A first participant “Jimmy” 202 has an associated electronic device 204. A second participant “Kim” 212 has an associated electronic device 214. A third participant “Walter” 222 has an associated electronic device 224. A fourth participant “Howard” 232 has an associated electronic device 234. One or more of the electronic devices 204, 214, 224, and 234 may be similar to electronic device 100 shown in FIG. 1A. Electronic devices 204, 214, 224, and 234 are communicatively connected to video conferencing server 250 via network 217 during a video communication session.

The video conferencing server 250 includes a processor 252. The processor 252 can include one or more cores. The processor 252 is coupled to system memory 254. System memory 254 can include a combination of volatile and non-volatile memories, such as DRAM, SRAM, Flash memory, and so on. The system memory 254 can include an operating system 256. In one or more embodiments, the operating system can include Windows, Linux, or other Unix variants. The system memory can include a video conference application 258. The video conferencing application 258 can include code, that when executed by the processor 252, performs various media processing functions such as transcoding, mixing, and encoding video and audio streams. The video conferencing application 258 can further include code, that when executed by the processor 252, performs various stream routing functions, such as directing AV streams between participants to minimize latency and ensure efficient use of bandwidth. Moreover, the code of video conferencing application 258 may provide support for implementing single sign-on (SSO), OAuth, or multi-factor authentication (MFA) for user verification. Additionally, the code of video conferencing application 258 may provide functionality for granting different levels of access to participants, such as host, co-host, presenter, or viewer. Furthermore, the code within video conferencing application 258 may provide support for recording and archiving of conferences. This can include storing video, audio, and shared content on the cloud with options for later access and editing, as well as automatically generating and storing meeting transcripts for later reference.

The video conferencing application 258 can further include code, that when executed by the processor 252, performs and/or implements one or more features of disclosed embodiments. The code can be included in Overridable Do Not Disturb (ODND) module 259, which can provide similar functionality to ODND module 125 as previously described. Other features may also be supported by the code of video conferencing application 258. System memory 254 can further include an account database 260. In one or more embodiments, the account database 260 can include a relation database, such as a structured query language (SQL) database. In one or more embodiments, for each participant, user credentials, profile details, and role-based permissions can be stored in the account database 260.

The video conferencing server 250 may further include a communication interface 262. The communication interface 262 may include one or more ethernet, gigabit ethernet (GbE), RJ-45 ports, SFP/SFP+/QSFP interfaces for fiber optic or high-speed copper connections, Fibre Channel (FC) interfaces, and/or other suitable communication interfaces. The video conferencing server 250 may include one or more storage devices 264. The storage devices may include solid-state drives (SSDs) 266, such as SATA SSDs, and/or NVMe SSDs for storing intermediate data, and may further include one or more hard disk drives (HDDs) 268, such as enterprise-grade HDDs which may be used for archiving recorded meetings and/or storing backups of user data and/or logs.

In one or more embodiments, as can be seen in FIG. 2A, stored within video conferencing server 250 is meeting agenda 267, which includes a timeslot and associated speaker for that timeslot. In one or more embodiments, of each participant listed in the agenda 267, for the indicated timeslot, the corresponding user can be considered to have an auditory state of speaking. One or more embodiments can include: detecting a pre-established agenda associated with the video conferencing session; determining a current time of day; determining a currently scheduled speaker of the video conferencing session, based on the pre-established agenda and the current time of day; and in response to the currently scheduled speaker being the user, identifying the current auditory state of the user as speaking.

FIG. 2B-FIG. 2G illustrate additional teleconferencing environment examples. For the purposes of clarity in the figures, the video conferencing server 250 and network 217 are not shown in FIG. 2B - FIG. 2G. The sequence of figures depicted in FIG. 2B-FIG. 2G show examples of verbal and text-based communication between meeting participants, and more particularly, the delaying of delivery of a text-based communication to a participant with an auditory state of speaking, and a non-delayed (immediate) deliver of a text-based communication to a participant with an auditory state of non-speaking.

FIG. 2B illustrates the example teleconferencing environment of FIG. 2A, showing the auditory state of each participant, according to one or more embodiments. As shown in FIG. 2B, Howard 232 is speaking, and Howard's microphone status 236 is unmuted. Howard's audio state is indicated as speaking at 237. The audio data detected by a microphone on Howard's device 234 is shown at 269, and a text representation of his speech is shown at 268. The other participants, including Jimmy 202, Kim 212, and Walter 222 each have a non-speaking auditory state, as indicated at 207, 217, and 227, respectively. Moreover, the microphone status for Kim 212 is muted, as indicated at 216, and the microphone status for Walter 222 is also muted, as indicated at 226. Although the microphone status of Jimmy 202 is unmuted, as indicated at 206, the audio state for Jimmy can be determined as non-speaking based on an absence of audio data corresponding to speech originating from his electronic device 204. One or more embodiments can include: detecting a mute status of a microphone associated with the electronic device; and in response to the mute status being muted, determining the current auditory state of the user as non-speaking. In one or more embodiments, in response to a microphone associated with the electronic device being in an unmute status: detecting whether speech audio data is being received from the microphone; and in response to detecting speech audio data, determining the current auditory state of the user as speaking.

FIG. 2C illustrates the example teleconferencing environment of FIG. 2A, showing additional conversation and text-based messaging destined to a non-speaking participant, according to one or more embodiments. The example shown in FIG. 2C is a continuation of the example shown in FIG. 2B. As shown in FIG. 2C, Walter 222 is composing a text-based message 229 on his electronic device 224. The details of the message are shown at 277, and the recipient of the message is indicated at 278 as Kim.

FIG. 2D illustrates the example teleconferencing environment of FIG. 2A, showing additional conversation and surfacing of a text-based message on an electronic device associated with a non-speaking participant, according to one or more embodiments. The example shown in FIG. 2D is a time continuation of the example shown in FIG. 2C, showing sending a text-based message to a speaking participant. As shown in FIG. 2D, because the auditory state of Kim 212 is non-speaking, as indicated at 217, the message sent by Walter (in FIG. 2C), is surfaced on the electronic device 214 associated with Kim 212, as indicated at 281. Thus, since the auditory state of Kim is non-speaking, the message 281 is immediately surfaced on her electronic device 214, without delay.

FIG. 2E is a continuation of the example shown in FIG. 2D. FIG. 2E illustrates the example teleconferencing environment of FIG. 2A, showing sending a text-based message to be sent to a speaking participant, according to one or more embodiments. As shown in FIG. 2E, Kim 212 is composing a text-based message 219 on her electronic device 214. The details of the message are shown at 282, and the recipient of the message is indicated at 283 as Howard, who is currently speaking, and has an auditory state of speaking, as indicated at 237.

FIG. 2F is a continuation of the example shown in FIG. 2E. FIG. 2F illustrates the example teleconferencing environment of FIG. 2A, showing delaying surfacing a message destined for a speaking participant, according to one or more embodiments. As shown in FIG. 2F, Howard 232 has continued to speak, and accordingly, the auditory state for Howard is still indicated as speaking, as shown at 237. Since the auditory state for Howard 232 is indicated as speaking at 237, the message 219 previously sent by Kim 212 (as illustrated in FIG. 2E), is suppressed. In one or more embodiments, the delivery of an incoming message and/or the notification of an incoming message is delayed until the auditory state of the recipient transitions from speaking to non-speaking.

FIG. 2G is a continuation of the example shown in FIG. 2F. FIG. 2G shows surfacing a message to a participant after the participant has transitioned from speaking to non-speaking, according to one or more embodiments. As shown in FIG. 2G, the auditory state corresponding to Howard 232 has transitioned from speaking to non-speaking, as indicated at 237. Conversely, the auditory state corresponding to Jimmy 202 has changed from non-speaking to speaking, as indicated at 207. The audio data detected by a microphone on Jimmy's device 204 is shown at 285, and a text representation of his speech is shown at 284. Since the auditory state associated with Howard 232 is non-speaking, as indicated at 237, the message indicated at 286 is surfaced on electronic device 234 that is associated with Howard 232. Message 286 received at electronic device 234 of Howard 232 originated from Kim 212 as indicated at 219 in FIG. 2E. However, since Howard 232 had an auditory state of speaking at that time (as indicated at 237 in FIG. 2E), the message was not surfaced on electronic device 234 that is associated with Howard 232 until his auditory state transitioned from speaking to non-speaking as indicated at 237 in FIG. 2G. Thus, disclosed embodiments can enable text-based communication that is delivered immediately when the auditory state of the recipient is non-speaking, and defer delivery and/or notification of text-based communications when the recipient has an auditory state of speaking. In this way, disclosed embodiments support efficient communication while reducing distractions for speaking participants. One or more embodiments can include: periodically monitoring the current auditory state; suppressing the incoming notification in response to determining the current auditory state of the user as speaking; detecting a change in current auditory state from speaking to non-speaking; and in response to detecting the change, surfacing the incoming notification that was suppressed.

While the aforementioned example shows the message sent from Kim 212 being deferred until Howard 232 transitioned his auditory state to non-speaking, in some embodiments, the role of the sender may also be used as a criterion to determine Do not Disturb override. For example, if Kim was the supervisor of Howard, a rule can be established (e.g., via a user configuration setting) to always allow text-based messages sent to Howard by Kim to be received without delay, regardless of the auditory state of Howard.

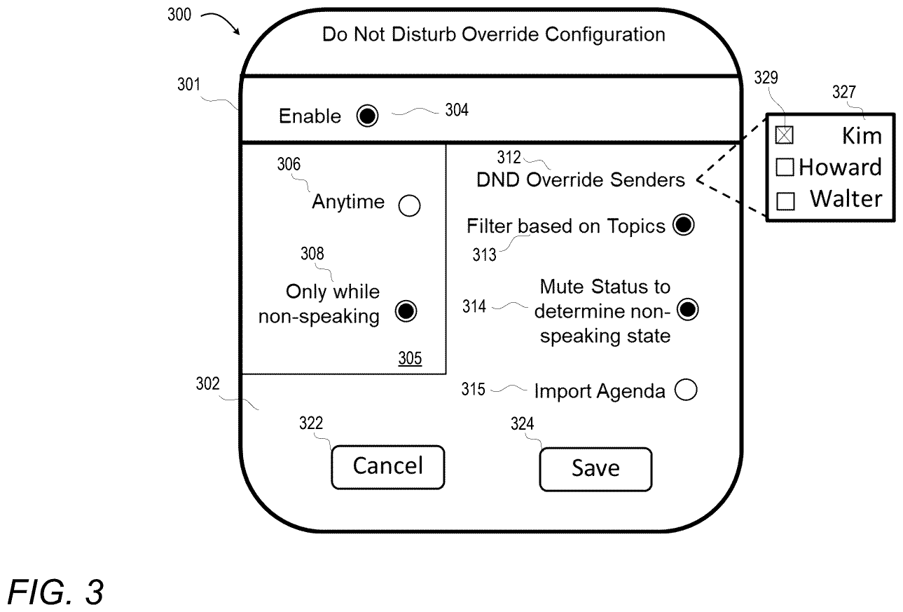

FIG. 3 illustrates an exemplary user interface for Do not Disturb override configuration presented on display of device 300, according to one or more embodiments. Device 300 may be similar to electronic device 100 depicted in FIG. 1A. Device 300 includes display 302 on which user interface 301 is presented. The user interface 301, which is rendered and presented on display 302, can include an option to enable the Do Not Disturb Override feature 304, which is indicated as selected in FIG. 3. The user interface 301 can include an option to select an operating mode, indicated at 305. The operating mode determines the conditions under which a notification/text-based message is delivered to a recipient, who is also a participant of the audio/video conference. Operating mode 305 includes a setting 306 to allow override of the do not disturb feature at any time, and another setting 308 to allow override of the Do not Disturb feature only while the recipient has a non-speaking auditory state. As shown in FIG. 3, setting 306 is unselected and setting 308 is selected.

The user interface 301 can include an option to specify DND override senders 312, which is indicated as selected in FIG. 3. When selected, the option to specify DND override senders 312 causes the processor within the electronic device 300 to render and present a submenu 327 that enables specifying one or more participants for which incoming text-based messages are delivered without delay, even if the recipient has an auditory state of ‘speaking.’ In one or more embodiments, each specified participant is added to a DND override list. In the example shown, the checkbox 329 next to Kim in submenu 327 is checked, indicating that an entry for Kim is created in the DND override list. As an example, a text-based message from a supervisor can be given a higher priority than text-based messages sent by other participants. In one or more embodiments, text-based messages from designated senders are always delivered immediately, regardless of the auditory state of the recipient.

The user interface 301 can include an option to filter incoming messages based on topics 313, which is indicated as selected in FIG. 3. When selected, the option to filter based on topics 313 causes the processor of the electronic device 300 to use the topic of a text-based message as a criterion in determining if the message is delivered immediately, or deferred. In one or more embodiments, natural language processing (NLP) techniques may be applied to the text-based message to determine a sentiment, topic, level of urgency, and/or other attributes. As an example, a text-based message having a topic that is relevant to the current discussion can be given a higher priority than other text-based messages.

The user interface 301 can include an option to use mute status to determine the non-speaking state 314, which is indicated as selected in FIG. 3. When selected, the option to use mute status to determine the non-speaking state 314 causes the processor within the electronic device 300 to use the mute status of the microphone of the electronic device as a criterion in determining if the corresponding user is in a speaking state or a non-speaking state. In one or more embodiments, when the mute status is “muted” (no audio is being acquired by the microphone of the electronic device), the auditory status of the user is set to non-speaking.

The user interface 301 can include an option to import an agenda 315, which is indicated as unselected in FIG. 3. When selected, the option to import an agenda 315 causes the processor of the electronic device 300 to access/retrieve and reference a stored agenda, such as shown at 267 in FIG. 2A, to determine an auditory state of a participant. As an example, based on agenda 267, when the current time of day falls between 10:00 am and 10:30 am, the participant Kim is given an auditory state of speaking. Similarly, when the current time of day falls between 10:30 am and 11:00 am, the participant Howard is given an auditory state of speaking. In one or more embodiments, in response to the currently scheduled speaker being a second participant, identifying the current auditory state of the user as non-speaking. A cancel option 322, when invoked, discards unsaved settings of the user interface of FIG. 3, and exits the user interface. A save option 324, when invoked, saves the settings of the user interface of FIG. 3 to memory, and exits the user interface.

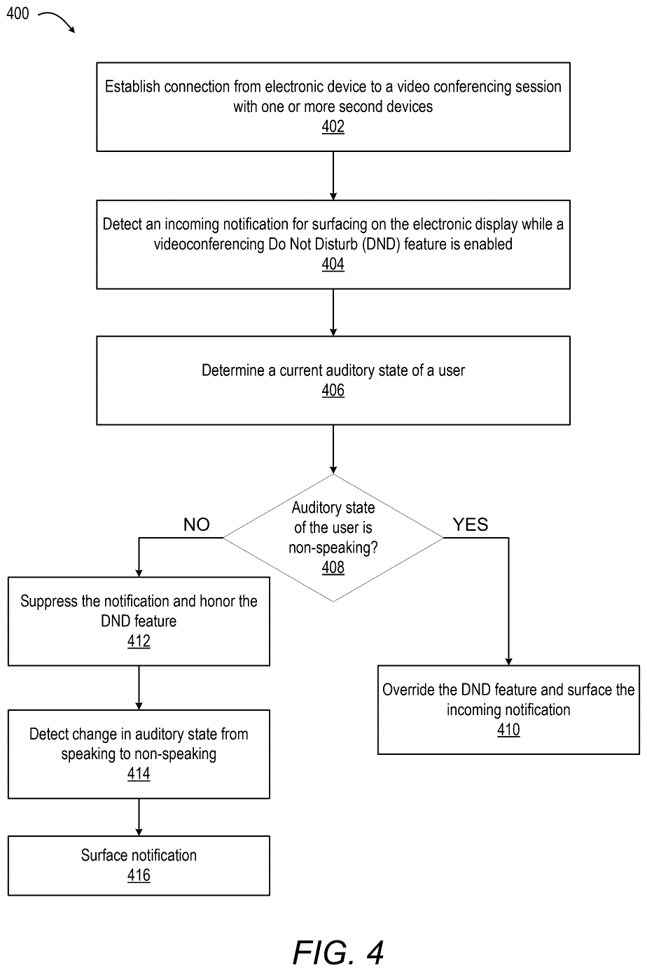

Referring now to the flowcharts presented by FIG. 4-FIG. 8, the descriptions of the methods in FIG. 4-FIG. 8 are provided with general reference to the specific components and features illustrated within the preceding FIGS. 1-3 . Specific components referenced in the methods of FIG. 4-FIG. 8 may be identical or similar to components of the same name used in describing preceding FIGS. 1-3 . In one or more embodiments, processor 112 (FIG. 1) configures electronic device 100 (FIG. 1) to provide the described functionality of the methods of FIG. 4-FIG. 8 by executing program code for one or more modules or applications provided within system memory 120 of electronic device 100, including Overridable Do Not Disturb (ODND) module 125.

FIG. 4 depicts a flowchart of a computer-implemented method for Do not Disturb override during video conferencing based on user auditory state, according to one or more embodiments. The method 400 starts at block 402, where a connection from an electronic device to a video conferencing session with one or more second devices is established. The connection that is established can use one or more network protocols, including, but not limited to, Real-Time Protocol (RTP), RTP Control Protocol (RTCP), Session Initiation Protocol (SIP), H.323, WebRTC, and/or other suitable protocols. The method 400 continues to block 404 where an incoming notification for surfacing on the electronic display is detected while a videoconferencing Do Not Disturb (DND) feature is enabled.

The method 400 continues to block 406, where a current auditory state of a user is determined. In one or more embodiments, the current auditory state of a user may be determined by analyzing the audio input from a participant's microphone, and detecting when sound above a certain threshold (e.g., speech) is present, which would indicate a speaking state. One or more embodiments may use AI models including natural language processing (NLP) to monitor incoming audio data to identify speech, distinguishing the speech from non-speech sounds such as typing or coughing. The mute status can also be used to conclusively determine a non-speaking auditory state, in cases where the user's microphone is muted. In one or more embodiments, after a predetermined duration where no speech is detected, an auditory state of a user, previously determined to be speaking, is automatically transitioned by the processor from speaking to non-speaking. In one or more example embodiments, the predetermined duration is three seconds. In such cases, three seconds after a user has last spoken, the processor transitions the auditory state of the user from speaking to non-speaking. Once the user starts speaking again, the speech is detected, and the auditory state transitions from non-speaking to speaking.

The method 400 continues to decision block 408, where a check is made to determine if the auditory state of a user (who is a recipient of a text-based message or notification) is non-speaking. If, at block 408, it is determined that the auditory state of the user is non-speaking, the method 400 continues to block 410, where the DND feature is overridden and the incoming notification is surfaced. If, at block 408, it is determined that the auditory state of the user is speaking, the method 400 continues to block 412, where the DND feature is not overridden and the incoming notification is suppressed and/or deferred until the auditory state transitions from speaking to non-speaking. The method 400 then continues to detecting a change in auditory state of a recipient from speaking to non-speaking at block 414. After the auditory state of the recipient is determined to have changed from speaking to non-speaking, the method 400 continues to block 416, where the notification is surfaced, such as illustrated in FIG. 2G.

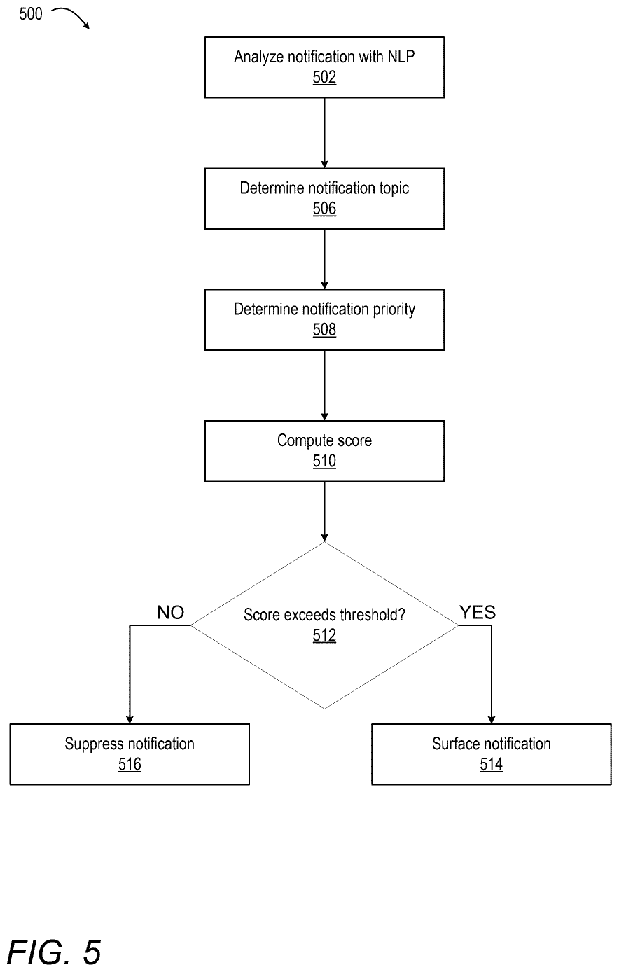

FIG. 5 depicts a flowchart of a computer-implemented method for Do not Disturb override during video conferencing based on a combination of user auditory state and additional override-enabling information, according to one or more embodiments. The method 500 starts at block 502, where an incoming notification, or text-based message is analyzed via natural language processing (NLP). Natural Language Processing (NLP) can include a variety of techniques to analyze text for topic, sentiment, urgency, and/or tone. The NLP techniques can combine computational linguistics, machine learning, and statistics to extract meaning and patterns from text. In one or more embodiments, the NLP techniques can include Latent Dirichlet Allocation (LDA), which can determine topics by grouping words that frequently occur together. One or more embodiments may include Non-Negative Matrix Factorization (NMF), which includes matrix decomposition methods to identify topics. Embodiments can further include using machine learning models (e.g., SVM, Naive Bayes, and/or neural networks) to categorize text into predefined topics. One or more embodiments may further include Named Entity Recognition (NER) to identify entities like names, organizations, and locations that can be indicative of specific topics. One or more embodiments may further include performing TF-IDF (Term Frequency-Inverse Document Frequency) to highlight important terms in the text that are unique to specific documents or topics. One or more embodiments may further utilize sentiment lexicons such as SentiWordNet to score words and phrases in order to establish a sentiment. One or more embodiments may include use of Hierarchical Attention Networks that are configured to focus on key parts of the text to extract hierarchical insights (e.g., topic, sentiment, and/or urgency). Other techniques may be used instead of, or in addition to, the aforementioned techniques for analyzing incoming notifications and/or text-based messages.

The method 500 continues to block 506, where the notification topic is determined, using natural language processing as previously described. One or more embodiments can include: determining a current topic of discussion for the video conferencing session; evaluating the incoming notification to determine a subject of the incoming notification; and selectively surfacing the incoming notification in response to the subject of the incoming notification being deemed relevant to the current topic of discussion.

The method 500 continues to block 508 where a notification (or text-based message) priority is determined. In embodiments, a keyword analysis can be performed to determine urgency. Embodiments can include: determining a priority of the incoming notification; and surfacing the incoming notification based on the priority of the incoming notification exceeding a pre-established priority threshold. One or more embodiments may utilize keyword matching to perform urgency assessment. For example, the keywords can include terms such as “immediate,” “asap,” or “emergency.” If one or more of these keywords are found, along with affirmative language, the message/notification may be deemed to be high priority, in which case, the DND setting may be overridden to allow the message/notification to be sent to the recipient without delay. The method 500 continues to block 510 where a score is computed. The score can be a function of the auditory state of the recipient, the sender of the notification/message, the topic of the notification/message, the priority of the notification/message, and/or other criteria. In one or more embodiments, the score can be normalized to be a value between 0 and 100, or other suitable range. The method 500 continues to block 512 where a check is made to determine if the score exceeds a predetermined threshold. If, at block 512, it is determined that the score exceeds the predetermined threshold, then the method 500 continues to block 514 where the notification/message is surfaced immediately, overriding the DND feature. If, at block 512, it is determined that the score does not exceed the predetermined threshold, then the method 500 continues to block 516 where the notification/message is delayed until the recipient has a non-speaking auditory state.

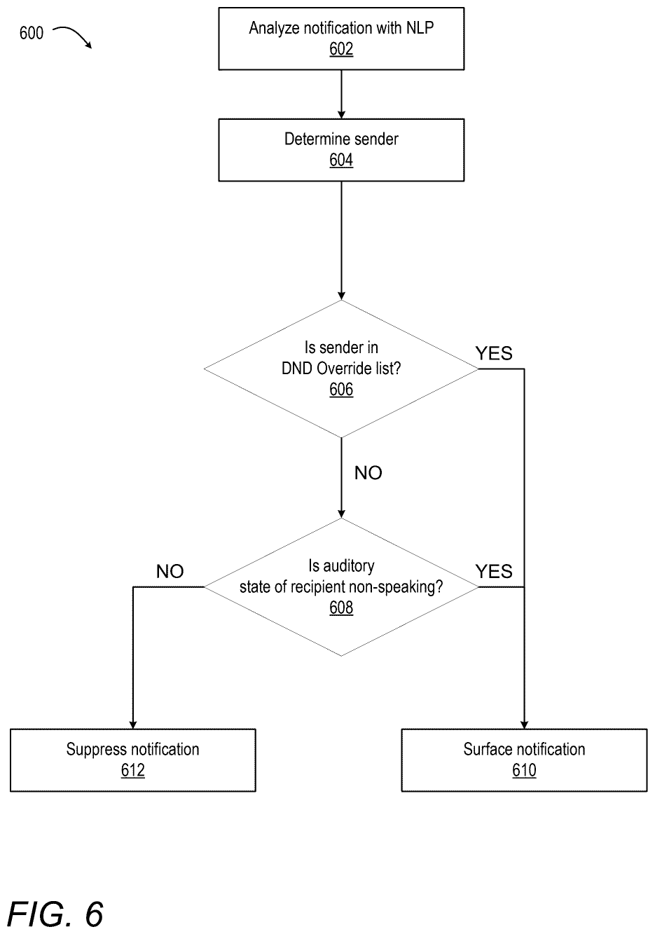

FIG. 6 depicts a flowchart of a computer-implemented method for Do not Disturb override during video conferencing based on a message sender, according to one or more embodiments. The method 600 starts at block 602, where an incoming notification, or text-based message is analyzed via natural language processing (NLP). The method 600 continues to block 604 where a sender of a text-based message is determined. The method 600 continues to block 606, where a check is made to determine if the sender is identified in a DND override list. If, at block 606, the sender is determined to be in the DND override list, the method 600 continues to block 610, where the notification is surfaced (rendered and presented) without additional delay. If, at block 606, the sender is determined not to be in the DND override list, the method 600 continues to block 608 where a check is made to determine if the auditory state of the recipient is non-speaking. If, at 608, the auditory state of the recipient is non-speaking, the method 600 continues to block 610, where the notification is surfaced without additional delay. If, at 608, the auditory state of the recipient is speaking, the method 600 continues to block 612, where the notification is suppressed, and not immediately surfaced.

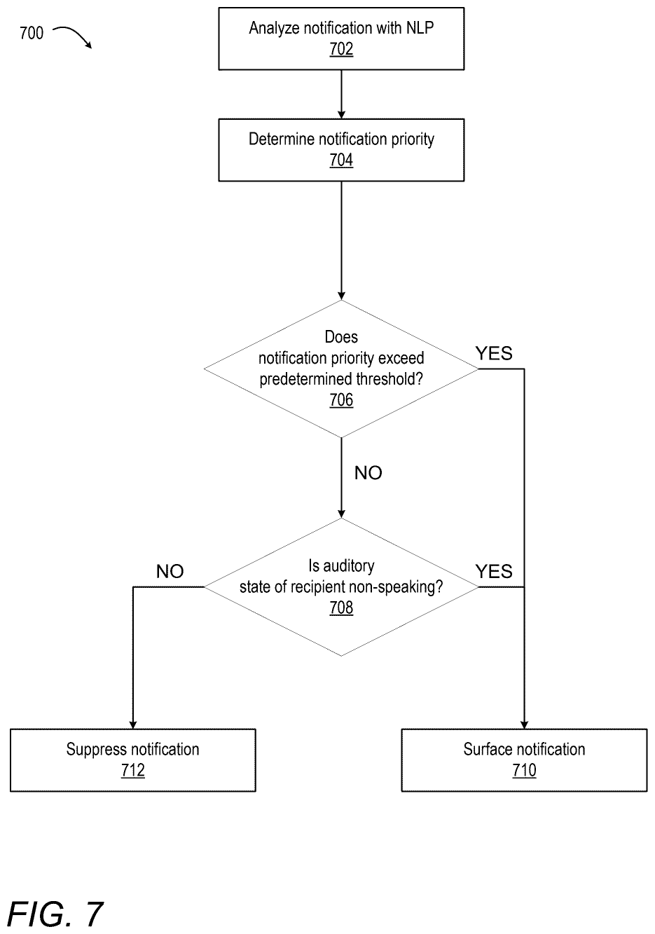

FIG. 7 depicts a flowchart of a computer-implemented method for Do not Disturb override during video conferencing based on a notification priority, according to one or more embodiments. The method 700 starts at block 702, where an incoming notification, or text-based message is analyzed via natural language processing (NLP). The method 700 continues to block 704 where a notification priority of a text-based message is determined. The method 700 continues to block 706, where a check is made to determine if the notification priority of the text-based message exceeds a predetermined threshold. In one or more embodiments, the sender of the text-based message has an option to set a priority for the text-based message. If, at block 706, the notification priority is determined to exceed a predetermined threshold, the method 700 continues to block 710, where the notification is surfaced (rendered and presented) without additional delay. If, at block 706, the notification priority is determined not to exceed a predetermined threshold, the method 700 continues to block 708 where a check is made to determine if the auditory state of the recipient is non-speaking. If, at 708, the auditory state of the recipient is non-speaking, the method 700 continues to block 710, where the notification is surfaced without additional delay. If, at 708, the auditory state of the recipient is speaking, the method 700 continues to block 712, where the notification is suppressed, and not immediately surfaced.

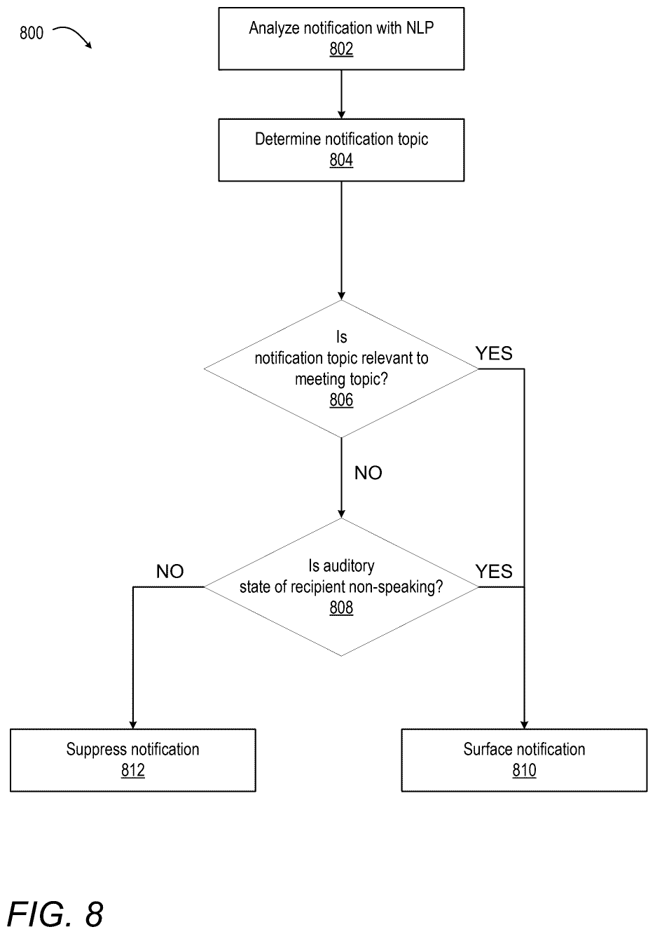

FIG. 8 depicts a flowchart of a computer-implemented method for Do not Disturb override during video conferencing based on a notification topic, according to one or more embodiments. The method 800 starts at block 802, where an incoming notification, or text-based message is analyzed via natural language processing (NLP). The method 800 continues to block 804 where a notification topic of a text-based message is determined. The method 800 continues to block 806, where a check is made to determine if the notification priority of the text-based message exceeds a predetermined threshold. In one or more embodiments, the topic of the text-based message is determined via NLP techniques. If, at block 806, the notification topic is determined to be relevant to the meeting topic, the method 800 continues to block 810, where the notification is surfaced (rendered and presented) without additional delay. In one or more embodiments, the meeting topic is determined via NLP techniques based on meeting transcripts and/or agenda notes. If, at block 806, the notification topic is determined not to be relevant to the meeting topic, the method 800 continues to block 808 where a check is made to determine if the auditory state of the recipient is non-speaking. If, at 808, the auditory state of the recipient is non-speaking, the method 800 continues to block 810, where the notification is surfaced without additional delay. If, at 808, the auditory state of the recipient is speaking, the method 800 continues to block 812, where the notification is suppressed, and not immediately surfaced.

The flowcharts, sequences, and configurations presented herein are provided solely for illustrative purposes and are exemplary in nature. These embodiments are not intended to be limiting and may include variations with more, fewer, and/or alternative options, sequences, or features as would be apparent to those skilled in the art.

As can now be appreciated, disclosed embodiments provide features for a video conferencing system that delay the delivery of instant messages to a participant while the participant is speaking. Disclosed embodiments allow speaking participants to concentrate on expressing their ideas without the distraction of incoming messages. The reduced distractions can help maintain the natural flow of conversation, improving clarity and participant engagement. Furthermore, speaking in meetings often requires real-time processing of thoughts and information. Avoiding interruptions with the use of disclosed embodiments can enable the speaker to focus entirely on their message. By managing message delivery intelligently, disclosed embodiments can minimize disruptions, leading to smoother discussions and fewer pauses. Thus, disclosed embodiments strike a balance between maintaining focus and delivering essential information, which can result in more productive meetings and enhanced participant satisfaction.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display;
a communications subsystem enabling the electronic device to communicatively connect to at least one second electronic device;
a memory having stored thereon a video conferencing application (VCA) comprising an Overridable Do Not Disturb (ODND) module; and
at least one processor coupled to the communications subsystem, the display, and the memory and which processes program code of the VCA and the ODND module, the at least one processor configured to cause the electronic device to:
establish a connection from the electronic device to a video conferencing session with one or more second devices, the electronic device operating as a conferencing system terminal for a participant to the video conferencing session comprising a plurality of participants;
detect an incoming notification for surfacing on the display of the electronic device, while a Do Not Disturb (DND) feature is enabled for the conferencing system terminal; and
in response to receiving the incoming notification while the DND feature is enabled:
determine a current auditory state of a user; and
in response to determining the current auditory state as a non-speaking state, override the DND feature, and surface the incoming notification.

2. The electronic device of claim 1, wherein further the at least one processor is configured to:
determine a priority of the incoming notification; and
surface the incoming notification based on the priority of the incoming notification exceeding a pre-established priority threshold.

3. The electronic device of claim 1, wherein further the at least one processor is configured to:
determine a current topic of discussion for the video conferencing session;
evaluate the incoming notification to determine a subject of the incoming notification; and
selectively surface the incoming notification in response to the subject of the incoming notification being deemed relevant to the current topic of discussion.

4. The electronic device of claim 1, wherein further the at least one processor is configured to:
determine a sender of the incoming notification; and
surface the incoming notification on the display in response to the sender of the incoming notification being another participant in the video conferencing session.

5. The electronic device of claim 1, wherein to determine a current auditory state of the user, the at least one processor is further configured to:
detect a mute status of a microphone associated with the electronic device; and
in response to the mute status being muted, determine the current auditory state of the user as non-speaking.

6. The electronic device of claim 1, wherein to determine a current auditory state of the user, the at least one processor is further configured to:
in response to a microphone associated with the electronic device being in an unmute status:
detect whether speech audio data is being received from the microphone; and
in response to detecting speech audio data, determine the current auditory state of the user as speaking.

7. The electronic device of claim 1, wherein to determine a current auditory state of the user, the at least one processor is further configured to:
detect a pre-established agenda associated with the video conferencing session;
determine a current time of day;
determine a currently scheduled speaker of the video conferencing session, based on the pre-established agenda and the current time of day; and
in response to the currently scheduled speaker being the user, identify the current auditory state of the user as speaking.

8. The electronic device of claim 7, wherein the at least one processor is further configured to:
in response to the currently scheduled speaker being a second participant, identify the current auditory state of the user as non-speaking.

9. The electronic device of claim 1, wherein the at least one processor is further configured to:
periodically monitor the current auditory state;
suppress the incoming notification in response to determining the current auditory state of the user as speaking;
detect a change in current auditory state from speaking to non-speaking; and
in response to detecting the change, surface the incoming notification that was suppressed.

10. A method comprising:
establishing, by at least one processor of an electronic device that includes an electronic display, a connection from the electronic device to a video conferencing session with one or more second devices, the electronic device operating as a conferencing system terminal for a participant to the video conferencing session comprising a plurality of participants;
detecting an incoming notification for surfacing on the electronic display while a Do Not Disturb (DND) feature is enabled for the conferencing system terminal; and
in response to receiving the incoming notification while the DND feature is enabled:
determining a current auditory state of a user; and
in response to determining the current auditory state as a non-speaking state, overriding the DND feature, and surfacing the incoming notification.

11. The method of claim 10, further comprising:
determining a priority of the incoming notification; and
surfacing the incoming notification based on the priority of the incoming notification exceeding a pre-established priority threshold.

12. The method of claim 10, further comprising:
determining a current topic of discussion for the video conferencing session;
evaluating the incoming notification to determine a subject of the incoming notification; and
selectively surfacing the incoming notification in response to the subject of the incoming notification being deemed relevant to the current topic of discussion.

13. The method of claim 10, further comprising:
determining a sender of the incoming notification; and
surfacing the incoming notification on the electronic display in response to the sender of the incoming notification being another participant in the video conferencing session.

14. The method of claim 10, wherein determining a current auditory state of the user comprises:
detecting a mute status of a microphone associated with the electronic device; and
in response to the mute status being muted, determining the current auditory state of the user as non-speaking.

15. The method of claim 10, wherein determining a current auditory state of the user comprises:
in response to a microphone associated with the electronic device being in an unmute status:
detecting whether speech audio data is being received from the microphone; and
in response to detecting speech audio data, determining the current auditory state of the user as speaking.

16. The method of claim 10, wherein determining a current auditory state of the user comprises:
detecting a pre-established agenda associated with the video conferencing session;
determining a current time of day;
determining a currently scheduled speaker of the video conferencing session, based on the pre-established agenda and the current time of day; and
in response to the currently scheduled speaker being the user, identifying the current auditory state of the user as speaking.

17. The method of claim 16, further comprising:
in response to the currently scheduled speaker being a second participant, identifying the current auditory state of the user as non-speaking.

18. The method of claim 10, further comprising:
periodically monitoring the current auditory state;
suppressing the incoming notification in response to determining the current auditory state of the user as speaking;
detecting a change in current auditory state from speaking to non-speaking; and
in response to detecting the change, surfacing the incoming notification that was suppressed.

19. A computer program product comprising a non-transitory computer readable medium having program instructions that when executed by a processor of an electronic device comprising an electronic display and a communications subsystem that enables the electronic device to communicatively connect to at least one second electronic device, configure the electronic device to perform functions comprising:
establishing a connection from the electronic device to a video conferencing session with one or more second devices, the electronic device operating as a conferencing system terminal for a participant to the video conferencing session comprising a plurality of participants;
detecting an incoming notification for surfacing on the electronic display while a Do Not Disturb (DND) feature is enabled for the conferencing system terminal; and
in response to receiving the incoming notification while the DND feature is enabled:
determining a current auditory state of a user; and
in response to determining the current auditory state as a non-speaking state, overriding the DND feature, and surfacing the incoming notification.

20. The computer program product of claim 19, further comprising program instructions for:
periodically monitoring the current auditory state;
suppressing the incoming notification in response to determining the current auditory state of the user as speaking;
detecting a change in current auditory state from speaking to non-speaking; and
in response to detecting the change, surfacing the incoming notification that was suppressed.
